(19) United States
(12) Patent Application Publication
(10) Pub. No.: US 2008/0075424 A1
(43) Pub. Date: Mar. 27, 2008

(54) METHODS FOR A DIGITAL VIDEO RECORDER TO USE OTHER STORAGE, PROGRAM AND TUNER RESOURCES

(76) Inventor: Tod A. DeBie, Costa Mesa, CA (US)

Correspondence Address: TOD DEBIE, 2190 PLACENTIA AVE., # C, COSTA MESA, CA, 92627, US

(21) Appl. No.: 11/535,077

(22) Filed: Sep. 26, 2006

(51) Int. Cl. H04N 5/91

(52) U.S. Cl. 386/83

(57) ABSTRACT

A method of enabling a digital video recorder to use the tuner resources of other digital video recorders, comprising checking for other available digital video recorders; and determining if said other available digital video recorders have an available tuner at the desired time.

### BACKGROUND OF THE INVENTION

1. Field of Invention

This invention generally relates to television program viewing and recording, specifically to the ability of one digital video record to use other storage, program and tuner resources.

2. Background of the Invention

Recording systems for television programs such as digital video recorders allow users to easily record selected programs. Digital video recorders typically include a tuner so that the broadcast of a desired program may be singled out and viewed or recorded, a storage medium where the system stored the program for later viewing and a user interface to enable the user to control what programs are recorded and what programs are viewed. They may also include a program guide, which shows what programs are on what channels at what times to enable the user to easily select a desired program for viewing or recording. Such systems may be entirely self contained, such as in a set top box, or they have multiple separate parts, such as separate tuners and storage mediums, such as in software based systems intended to run on one or more computers with storage and tuners, etc. Such systems have one or more tuners and the number of programs they can record simultaneously are limited to the number of tuners in the system such that a system with two tuners would allow any of the following: the user can watch one live program, the user can watch one live program and record another, or the user can record two programs but cannot watch a live program other than the two being recorded. Some systems will allow the user to watch a pre-recorded program while all of the tuners are busy recording live programs.

A common issue encountered in the course of using a digital video recorder is a recording conflict. A recording conflict occurs when there are not enough tuners available to record all desired programs. A recording conflict also occurs when there are not enough tuners available to record all desired programs while servicing a live program viewing request from the user.

For example, if a two tuner digital video recorder is currently recording two programs and the user wants to either record or watch a third program, a recording conflict arises because there are not enough tuners available to service all the requests.

When a recording conflict occurs in existing systems, they typically give the user the option to either keep the current recording(s) going or to abandon one of them in favor of the new recording or viewing selection. If the user wants to record or view all of the programs, they will have to manually search for other times when the programs are on and manually set them to record or watch them live to resolve the conflict, or they will have to manually check to see if the desired program is available via video on demand. This is undesirable and may cause the loss of recorded information as well as inconveniencing a potential end user.

Other issues are encountered when there is insufficient storage space to store a program that is about to be recorded. Existing systems may use various algorithms to determine which currently stored programs should be deleted from storage to make space for the program about to be recorded or if the upcoming recording should abandoned so that all of the currently stored programs may be saved. This is undesirable and may cause the loss of recorded information as well as inconveniencing a potential end user.

Other common issues include cases where a user has two digital video recorders, each located in a different room, and the user wants to watch a given program on digital video recorder A, but the program is stored on digital video recorder B. Existing systems may let the user physically go to digital video recorder B and “push” or copy the program to A. This is undesirable, time consuming and in some cases impractical.

There remains a need in the art for systems and methods to resolve these and other problems in a more efficient manner.

### SUMMARY

Accordingly, several advantages are provided, according to one or more embodiments, which may include allowing one digital video recorder to discover other digital video recorders at the same location and determine if any of the other digital video recorders at the same location are able to help resolve a recording conflict or if they have a program desired by the user stored and, if so, play it on the digital video recorder that the user is using.

According to one embodiment, a method of enabling a digital video recorder to use the tuner resources of other digital video recorders, comprising checking for other available digital video recorders; and determining if the other available digital video recorders have an available tuner at the desired time, whereby one advantage is that one digital video recorder may set programs to record on another.

According to one embodiment, a method of enabling a digital video recorder to use other storage devices, comprising checking for other available storage devices; and determining if the other storage devices have available storage space, whereby one advantage is that one digital video recorder may store programs on another.

According to one embodiment, a method of enabling a digital video recorder to discover and playback programs stored on other devices, comprising: checking for other available devices with stored programs; and enumerating programs stored on said other devices, whereby one advantage is that one digital video recorder may playback programs stored on another.

Further advantages will become apparent from a consideration of the drawings and ensuing description.

### BRIEF DESCRIPTION OF DRAWINGS

Aspects of this disclosure are illustrated by way of example, and not by way of limitation, in the accompanying drawings, wherein:

FIG. 1 depicts an embodiment of an exemplary method for one digital video recorder to use the tuner resources of another to resolve viewing and recording conflicts;

FIG. 2 depicts an embodiment of an exemplary method for one digital video recorder to use other storage resources; and

FIG. 3 depicts an embodiment of an exemplary method for one digital video recorder to access stored programs on other devices.

### DETAILED DESCRIPTION

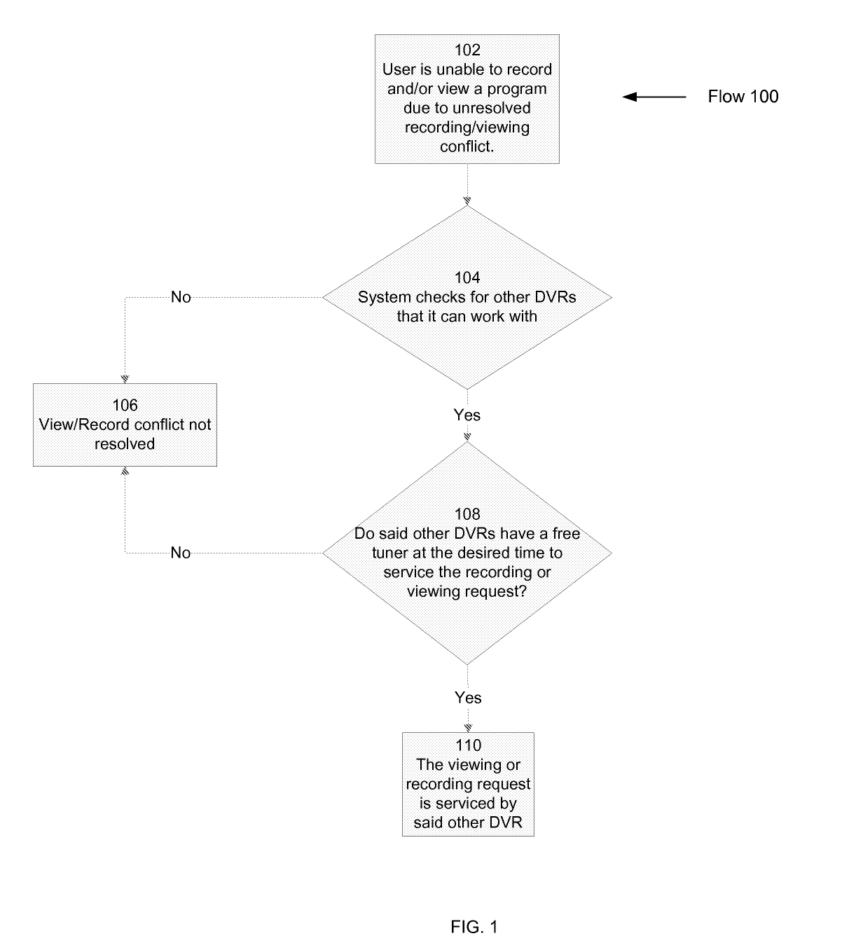

FIG. 1 depicts a flowchart of an exemplary method for one digital video recorder to use the tuner resources of another to resolve viewing and recording conflicts. In reference to FIG. 1, an exemplary recording resolution flow 100 may comprise one or more operations as follows:

In operation 102, a user is unable to record and/or view a program due to unresolved viewing and/or recording conflicts.

For example, if a user wants to record program A and B, both of which are playing at the same time but on different channels and the user is working with a single tuner DVR, a recording conflict is encountered.

In operation 104, the system determines if other digital video recorders are available to work with. According to one embodiment, digital video recorders can be networked together over such mediums as Ethernet, power lines, wireless, cable lines and phone lines. Through this network, the system can send out a request signal that other digital video recorders can respond to so as to indicate if they are or are not able to cooperate.

In another embodiment, all of the digital video recorders will push information as to their status out to all of the other digital video recorders on the same network.

In another embodiment, one digital video recorder can be manually configured to discover another. For example, this may involve entering the network or other type of address or identifier of one digital video recorder into another such that one can discover the other. In some embodiments, when digital video recorder A is manually configured to discover digital video recorder B, the two may communicate such that digital video recorder B may also discover A, and B may discover all of the digital video recorders that A may know about. In other embodiments, when digital video recorder A is manually configured to discover digital video recorder B, B may have to be manually configured to discover A.

Still other embodiments may use various other methods for digital video recorders to communicate their existence and availability to each other.

In some embodiments, the system may keep a list of all discovered digital video recorders in operation 104, whether they were manually or automatically discovered such that operation 104 may simply be a review of the list of discovered digital video recorders kept on the digital video recorder and not an actual discovery process.

In some embodiments, there may be an option to discover new digital video recorders without going through any other part of the process to resolve recording conflicts.

In some embodiments, operation 104 may only involve a check that the stored list of devices is valid.

If no digital video recorders are found to be available in operation 104, the system will go to operation 106 and the conflict will remain unresolved. If one or more digital video recorders are found to be available in operation 104, the system will go to operation 108.

In operation 108, the system determines if any of the other available digital video recorders have a tuner available to service the desired recording or viewing request at the desired time.

For example, if a user is working with digital video recorder A and encounters a recording or viewing conflict, the system will check for other digital video recorders it can work with in operation 104 and in operation 108 it will check with each available digital video recorder to see if it has a tuner available at the desired time to service the viewing or recording request, such as channel 11 at 10 PM today for 30 min, channel 22 right now for an hour or channel 33 on Jul. 4, 2007 at 9 PM for two hours.

If no tuners are found to be available in operation 108, the system will go to operation 106 and the conflict will remain unresolved. If a tuner is found to be available to service the request in operation 108, the system will go to operation 110.

Some embodiments may combine operations 104 and 108 by sending out the check for availability request along with the specific check for availability to resolve the recording conflict or by other means.

In operation 110, the viewing or recording request is service by the other digital video recorder. In the case of a recording request, the other digital video recorder is set to record the desired program at the desired time. In the case of a viewing request, the digital video recorder with the available tuner will receive the program from the television service provider and then send the program over the network to the digital video recorder that the user is using so that the user may view the program from the digital video recorder that they are currently using.

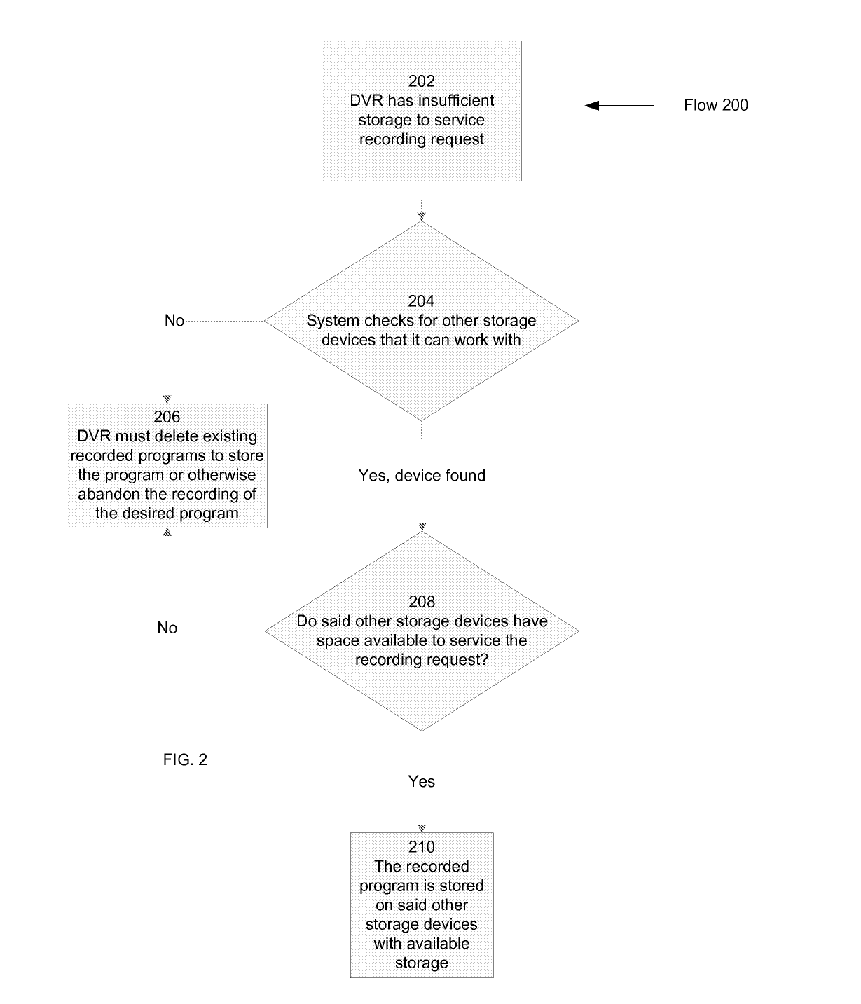

FIG. 2 depicts a flowchart of an exemplary method for one digital video recorder to use other storage devices. In reference to FIG. 2, an exemplary storage device usage flow 200 may comprise one or more operations as follows:

In operation 202, a digital video recorder determines that it has insufficient storage space to store a program that is about to be recorded. For example, the digital video recorder may have 40 Gb of storage, 39.75 Gb of which are currently in use, leaving 0.25 Gb free. An upcoming recording may take 2 Gb and therefore there may be insufficient storage space for the upcoming recorded program.

In operation 204, the system determines if other storage devices are available to work with. According to one embodiment, digital video recorders can be networked over such mediums as Ethernet, power lines, wireless, cable lines and phone lines. Through this network, the system can send out a request signal that other storage devices can respond to so as to indicate if they are or are not able to cooperate.

In another embodiment, all of the storage devices will push information as to their status out to all of the other devices on the same network. Still other embodiments will use various methods for digital video recorders to discover the availability of other storage devices.

These storage devices may be digital video recorders, personal computers, game consoles, network attached storage or other types of storage devices.

In another embodiment, one digital video recorder can be manually configured to discover storage devices. For example, this may involve entering the network or other type of address of a storage device into a digital video recorder such that the digital video recorder knows about and can interact with the storage device. In some embodiments, when a digital video recorder is manually configured to discover a storage device, the storage device may communicate to the digital video recorder all of the other storage devices it is aware of, such that the digital video recorder can use all of the known storage devices. In other embodiments, each storage devices may have to be manually programmed.

Still other embodiments may use various other methods for digital video recorders to discover the existence and availability of other storage devices.

In some embodiments, the system may keep a list of all discovered storage devices in operation 204, whether they were manually or automatically discovered such that operation 204 may simply be a review of the list of discovered storage devices kept on the digital video recorder and not an actual discovery process. In these embodiments, there may be an option to discover new storage devices without going through any other part of the process to store programs on the devices.

In some embodiments, operation 204 may only involve a check that the stored list of devices is valid.

If no storage devices are found to be available in operation 204, the system will go to operation 206 and the system will have to delete existing stored programs to store the upcoming recording or otherwise abandon the upcoming recording. If one or more storage devices are found to be available in operation 204, the system will go to operation 208.

In operation 208, the system determines if any of the storage resources that it can communicate with have sufficient storage available to store the upcoming program recording. If there is sufficient storage, the system moves to operation 210. If there is not sufficient storage, the system moves to operation 206.

Some embodiments may combine operations 204 and 208 by sending out the check for storage device availability request along with the specific check for sufficient available storage or by other means.

In operation 210, the desired program is stored on the storage devices with the necessary storage available.

In one embodiment, the program is received from the television service provider via the tuner on the digital video recorded that the user was using when the program was set to record and transferred for storage over the network to the storage devices with the necessary available storage.

In another embodiment, when the discovered storage device with available storage happens to be another digital video recorder, the program recording job may be transferred to the digital video recorder with the necessary available storage such that it receives the program from the television service provider on its own tuners and stores it on its own storage.

In some embodiments, the program stored on a single storage device. In other embodiments, the program is divided up and stored wherever space is available across multiple storage devices.

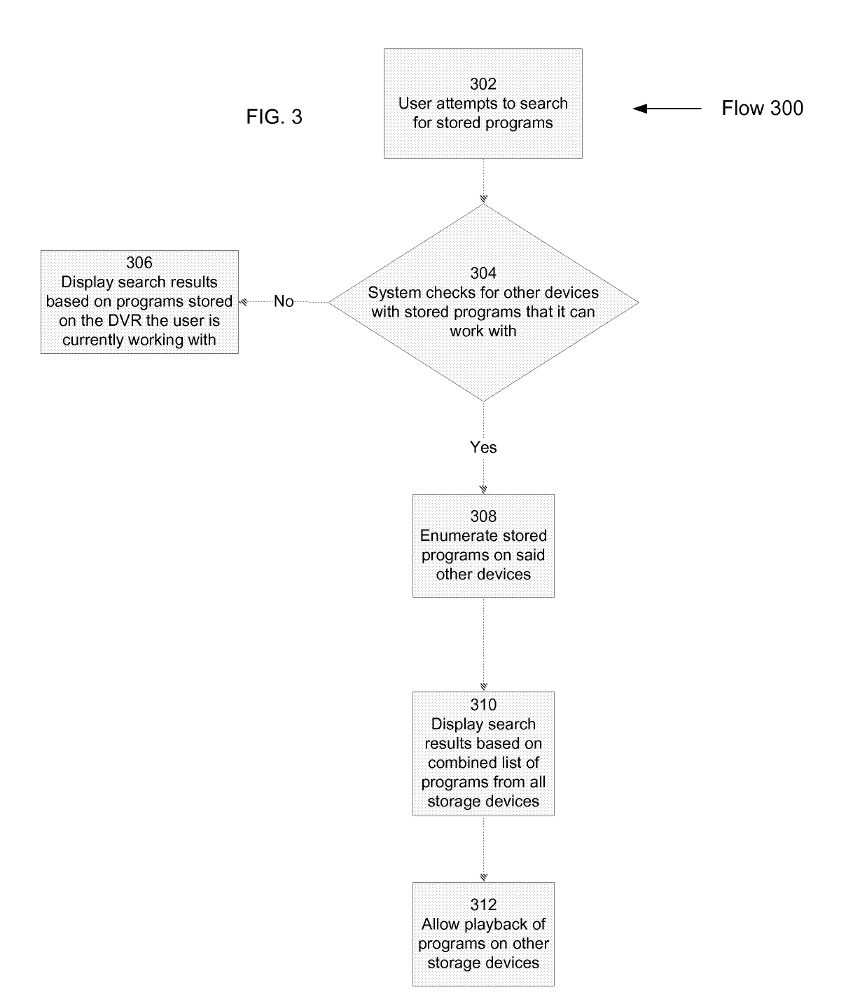

FIG. 3 depicts a flowchart of an exemplary method for one digital video recorder to access the stored programs of other devices. In reference to FIG. 3, an exemplary stored program access flow 300 may comprise one or more operations as follows:

In operation 302, a user is attempting to search for stored programs on a digital video recorder. The search operation may include browsing, searching or other operations for the user to locate stored programs.

In operation 304, the system determines if other devices with stored programs are available to work with. According to one embodiment, digital video recorders can be networked over such mediums as Ethernet, power lines, wireless, cable lines and phone lines. Through this network, the system can send out a request signal that other devices with stored programs can respond to so as to indicate if they are or are not able to cooperate.

In another embodiment, all of the devices with stored programs will push information as to their status out to all of the other digital video recorders on the same network. Still other embodiments will use various methods for devices with stored programs to communicate their availability to each other.

In another embodiment, one digital video recorder can be manually configured to discover devices with stored programs. For example, this may involve entering the network or other type of address of devices with stored programs into a digital video recorder such that the digital video recorder knows about and can interact with the device. In some embodiments, when a digital video recorder is manually configured to discover devices with stored programs, the devices with stored programs may communicate to the digital video recorder all of the other devices with stored programs they may be aware of, such that the digital video recorder can use all of the devices with stored programs. In other embodiments, each device with stored programs may have to be manually programmed.

Still other embodiments may use various other methods for digital video recorders to discover the existence and availability to other devices with stored programs.

In some embodiments, the system may keep a list of all discovered devices with stored programs in operation 304, whether they were manually or automatically discovered such that operation 304 may simply be a review of the list of discovered devices with stored programs kept on the digital video recorder and not an actual discovery process. In these embodiments, there may be an option to discover new devices with stored programs without going through any other part of the process to use stored programs on the devices.

In some embodiments, operation 304 may only involve a check that the stored list of devices is valid.

If no devices with stored programs are found to be available in operation 304, the system will go to operation 306 and the system will display results of the search based on programs stored on the digital video recorder that the user is currently working with. If one or more devices with stored programs are found to be available in operation 304, the system will go to operation 308.

In operation 308, the system enumerates the programs stored on the devices with stored programs discovered to be available in operation 304.

Some embodiments may combine operations 304 and 308 by sending out the check for the availability of devices with stored programs along with the specific check to enumerate the stored programs.

These devices with stored programs may be other digital video recorders, personal computers, game consoles, network attached storage or other types of storage devices. The stored programs may be any type of video or audio.

In operation 310, the system displays the results of the search based on the combined list of all stored programs from all accessible devices with stored programs.

In operation 312, the system allows the user to play a selected recorded program from another storage device. The play operation may include copying the selected program to the digital video recorder that the user is working with and then playing it back for the user, or streaming the selected program from the storage device that has the selected stored program from to the digital video recorder that the user desires to view it on without actually storing it on the digital video recorder that the user desires to view it on.

I claim:

1. A method of enabling a digital video recorder to use the tuner resources of other digital video recorders, comprising:
checking for other available digital video recorders; and
determining if the other available digital video recorders have an available tuner at the desired time.

2. The method of claim 1, further comprising:
selecting a desired program to record on the other digital video recorder with available tuner;
communicating the desired program to the other digital video recorder with available tuner; and
setting the desired program to record on the other digital video recorder.

3. The method of claim 1, further comprising:
streaming the desired program from the digital video recorder with the available tuner to the digital video recorder where the user wants to watch the program, whereby the user can watch the program without requiring the use of tuners in the digital video recorder that the user is currently using.

4. The method of claim 3, further comprising:
saving the streamed program as a stored program on the digital video recorder.

5. A method of enabling a digital video recorder to use other storage devices, comprising:
checking for other available storage devices; and
determining if the other storage devices have available storage space.

6. The method of claim 5, further comprising:
storing a recorded program on the other storage device with available storage space.

7. The method of claim 5, further comprising:
breaking up a program and storing it on multiple other storage devices with available storage space.

8. The method of claim 5, further comprising:
transferring the recording job to said other storage device whereby the program is recorded by and stored on said other storage device.

9. A method of enabling a digital video recorder to discover and playback programs stored on other devices, comprising:
checking for other available devices with stored programs; and
enumerating programs stored on said other devices.

10. The method of claim 9, further comprising:
displaying search results based on a combined list of programs from all storage devices.

11. The method of claim 9, further comprising:
streaming a desired program from a storage device to a digital video recorder.

12. The method of claim 11, further comprising:
saving the streamed program as a stored program on the digital video recorder.

13. The method of claim 11, further comprising:
playing the stream as it comes in whereby the user can view the program as it is streamed in.
